(19) United States
(12) Patent Application Publication
(10) Pub. No.: US 2025/0205607 A1
(43) Pub. Date: Jun. 26, 2025

(54) INFORMATION PROCESSING APPARATUS AND PATCH FILE DOWNLOADING METHOD

(71) Applicant: Sony Interactive Entertainment Inc., Tokyo (JP)

(72) Inventors: Fumihiko Iida, Kanagawa (JP); Syunsuke Bamba, Tokyo (JP); Atsushi Hamano, Tokyo (JP); Keiichi Aoki, Kanagawa (JP); Kazuki Soma, Kanagawa (JP)

(73) Assignee: Sony Interactive Entertainment Inc., Tokyo (JP)

(21) Appl. No.: 18/855,398

(22) PCT Filed: May 13, 2022
(86) PCT No.: PCT/JP2022/020163

§ 371 Date: Oct. 9, 2024

(51) Int. Cl. A63F 13/69; G06F 8/65

(52) U.S. Cl. CPC A63F 13/69; G06F 8/65; A63F 2300/638

(57) ABSTRACT

A setting section 80 sets an automatic download processing execution time which is set according to a predicted time of startup of the information processing apparatus. A download processing section 82 executes automatic download processing of a patch file at the set execution time.

### TECHNICAL FIELD

The present disclosure relates to a technology of downloading patch files.

### BACKGROUND ART

Game functions and scenarios are constantly added for the purpose of providing new experiences to users. By installing a most up-to-date patch file onto a game apparatus, a user can play a game in the most up-to-date state. However, it takes some time to download and install the patch file.

PTL 1 discloses a game apparatus that starts up an automatic download function at a set time, automatically makes access to a patch file providing server, and automatically downloads a patch file for a game. In this game apparatus, an automatic download start time is initially set to a predetermined time (4:00), but a user is allowed to change the automatic download start time to any time (for example, 2:00) that the user likes. In the game apparatus disclosed in PTL 1, the most up-to-date patch version information for a most recently executed game is acquired from the patch file providing server, and, in a case where the most up-to-date patch version information indicates a version that is newer than patch version information recorded in the startup history, the most up-to-date patch file stored in the patch file providing server is determined to be downloaded.

### CITATION LIST

### Patent Literature

[PTL 1] JP 2012-3329A

### SUMMARY

### Technical Problem

In the technology disclosed in PTL 1, in a case where the patch file providing server has released a most up-to-date patch file and a user tries to play the game before a set time for starting up the automatic download function, the most up-to-date patch file has not yet been installed on the game apparatus. Hence, the user has to wait until the game apparatus finishes downloading and installing the most up-to-date patch file.

In view of this, an object of the present disclosure is to provide a technology of downloading a most up-to-date patch file prior to start of a user's game play.

### Solution to Problem

In order to solve the above problem, an information processing apparatus according to a certain aspect of the present disclosure is an information processing apparatus that executes game software, and includes a setting section that sets an automatic download processing execution time which is set according to a predicted time of startup of the information processing apparatus, and a download processing section that executes automatic download processing of a patch file at the set execution time.

Another aspect of the present disclosure is a method for downloading a patch file for game software onto an information processing apparatus. The method includes a step of setting an automatic download processing execution time which is set according to a predicted time of startup of the information processing apparatus, and a step of executing automatic download processing of the patch file at the set execution time.

It is to be noted that a method, an apparatus, a system, a recording medium, a computer program, or the like that is obtained by translating a desired combination of the above constituent elements or an expression in the present disclosure is also effective as an aspect of the present disclosure.

### BRIEF DESCRIPTION OF DRAWINGS

FIG. 1 is a diagram depicting an information processing system according to an embodiment.

FIG. 2 indicates an example of predicted values predicted by a behavior prediction model.

FIG. 3 is a diagram depicting a hardware configuration of an information processing apparatus.

FIG. 4 is a diagram depicting functional blocks for performing automatic downloading.

FIG. 5 is a flowchart for performing automatic downloading.

FIG. 6 is a diagram depicting a time relation between release of a patch and behaviors of the information processing apparatus.

FIG. 7 is a diagram depicting a time relation between release of a patch and behaviors of the information processing apparatus.

### DESCRIPTION OF EMBODIMENT

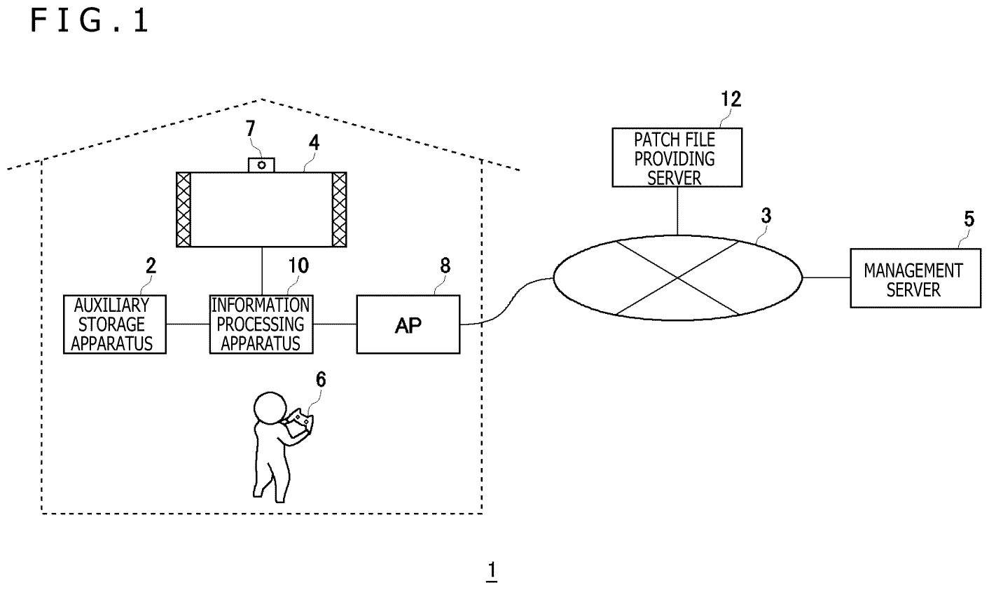

FIG. 1 depicts an information processing system 1 according to an embodiment of the present disclosure. The information processing system 1 includes an information processing apparatus 10, a management server 5, and a patch file providing server 12 that provides patch files for updating game software. The apparatus and the servers are connected to each other over a network 3 which is, for example, the internet or a LAN (Local Area Network). An access point (hereinafter, referred to as an “AP”) 8 has a wireless access point function and a router function. By establishing wireless or wired connection with the AP 8, the information processing apparatus 10 establishes connection to become communicable with the management server 5 and the patch file providing server 12 on the network 3.

The information processing apparatus 10 establishes wireless or wired connection with an input apparatus 6 being operated by a user, and the input apparatus 6 outputs user operation information to the information processing apparatus 10. The information processing apparatus 10 reflects the operation information outputted from the input apparatus 6, in processing performed by an operating system or software, and outputs the processing result through an output apparatus 4. The information processing apparatus 10 may be a terminal apparatus such as a personal computer or a game apparatus that executes game software. The input apparatus 6 may be such an apparatus as a game controller that supplies user operation information to the information processing apparatus 10.

The input apparatus 6 includes a plurality of input parts including a plurality of push-type operation buttons, an analog stick through which an analog amount can be inputted, and a turnable button, and the like. A camera 7, which is an imaging apparatus, is disposed near the output apparatus 4, and captures an image of the surrounding space of the output apparatus 4. The camera 7 is mounted on the output apparatus 4 in FIG. 1, but may be disposed next to the output apparatus 4. In either case, the camera 7 is positioned to be capable of capturing an image of a user playing a game in front of the output apparatus 4. The camera 7 may be a stereo camera.

An auxiliary storage apparatus 2 is a large capacity storage such as an SSD (Solid State Drive) or an HDD (Hard Disk Drive), and may be a built-in storage apparatus or may be an external storage apparatus that is connected to the information processing apparatus 10 via a USB (Universal Serial Bus) or the like. The output apparatus 4 may be a television set equipped with a display for outputting images and a loudspeaker for outputting sounds, or may be a head-mounted display. The output apparatus 4 may be connected to the information processing apparatus 10 via a cable, or may be wirelessly connected to the information processing apparatus 10.

The management server 5 is maintained and managed by an operation entity of the information processing system 1, and provides a network service to a user of the information processing system 1. The management server 5 manages a network account for identifying the user. The user uses the network account to sign in to a network service being provided by the management server 5. After signing in to the network service through the information processing apparatus 10, the user is allowed to receive provision of a patch file from the patch file providing server 12.

The information processing apparatus 10 provides various kinds of information to the management server 5. In the embodiment, the information processing apparatus 10 may provide at least the following history information to the management server 5. The information processing apparatus 10 may provide the history information to the management server 5 each time a state change occurs. Alternatively, the information processing apparatus 10 may provide the history information to the management server 5 collectively at a predetermined timing.

### Game Play Data

Game play data refers to information regarding a game play history which includes titles (game titles) of games played by the user and play start times and end times of the games.

### Power State Data

Power state data refers to history information indicating the use state of the information processing apparatus 10. The power state data includes a power state such as a power-on state, a standby mode (rest mode), or a power-off state and a time when a power state change has occurred being associated with each other.

### Party Information

Party information refers to information indicating that the user has played a game with a friend.

### Purchase Information

Purchase information refers to information indicating that the user has purchased additional game data.

The management server 5 acquires the history information from each of the information processing apparatuses 10 participating in the information processing system 1. By machine learning of the history information acquired from each of the information processing apparatuses 10, the management server 5 creates a behavior prediction model for predicting a behavior of each of the information processing apparatuses 10. The behavior prediction model predicts a time period during which the information processing apparatus 10 will be on in a day and the title of a game which will be played by the user.

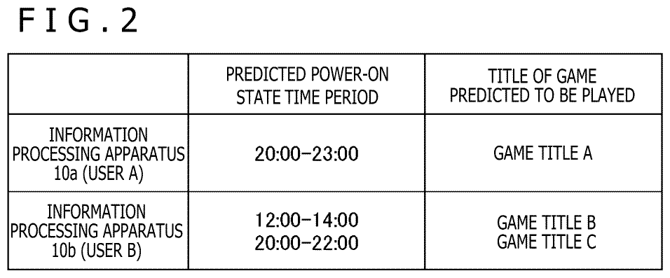

FIG. 2 indicates an example of predicted values predicted by the behavior prediction model. The behavior prediction model predicts that an information processing apparatus 10a that a user A operates will be on from 20:00 to 23:00, and that a game of a title A will be played during this time period. These predicted values are generated by machine learning, through the behavior prediction model, regarding past history information indicating that, recently, the user A has turned on the information processing apparatus 10a at around 20:00, played the game of the title A, and ended the game play and brought the information processing apparatus 10a into a standby mode at around 23:00.

Further, the behavior prediction model predicts that an information processing apparatus 10b that a user B operates will be on from 12:00 to 14:00 and from 20:00 to 22:00, and that a game of a title B and/or a title C will be played during these time periods. These predicted values are generated by machine learning, through the behavior prediction model, regarding past history information indicating that, recently, the user B has turned on the information processing apparatus 10b at around 12:00, played the game of the title B and/or the title C, and ended the game play and brought the information processing apparatus 10b into a standby mode at around 14:00, and that, recently, the user B has turned on the information processing apparatus 10b at around 20:00, played the game of the title B and/or the title C, and ended the game play and brought the information processing apparatus 10b into a standby mode at around 22:00.

It is to be noted that the management server 5 may have a function of predicting a time period during which the information processing apparatus 10 will be on in a day and the title of a game which will be played by the user, by statistically processing the past history information regarding the information processing apparatus 10. In any case, the management server 5 has a function of predicting a time period during which the information processing apparatus 10 will be on and the title of a game which will be played by the user, by analyzing various kinds of history information collected from the information processing apparatus 10.

The patch file providing server 12 holds the most up-to-date patch file for game software, and provides the patch file to the information processing apparatus 10 in response to a download request from the information processing apparatus 10. At a set time, the information processing apparatus 10 inquires of the patch file providing server 12 whether there is a patch file to be downloaded, and, in a case where there is, transmits a download request to the patch file providing server 12 and automatically downloads the patch file to be downloaded. It is to be noted that, at a time when the patch file providing server 12 is allowed to distribute a new patch file, the information processing apparatus 10 may be notified of that effect, may transmit a download request to the patch file providing server 12 at a set time, and may automatically download the patch file to be downloaded.

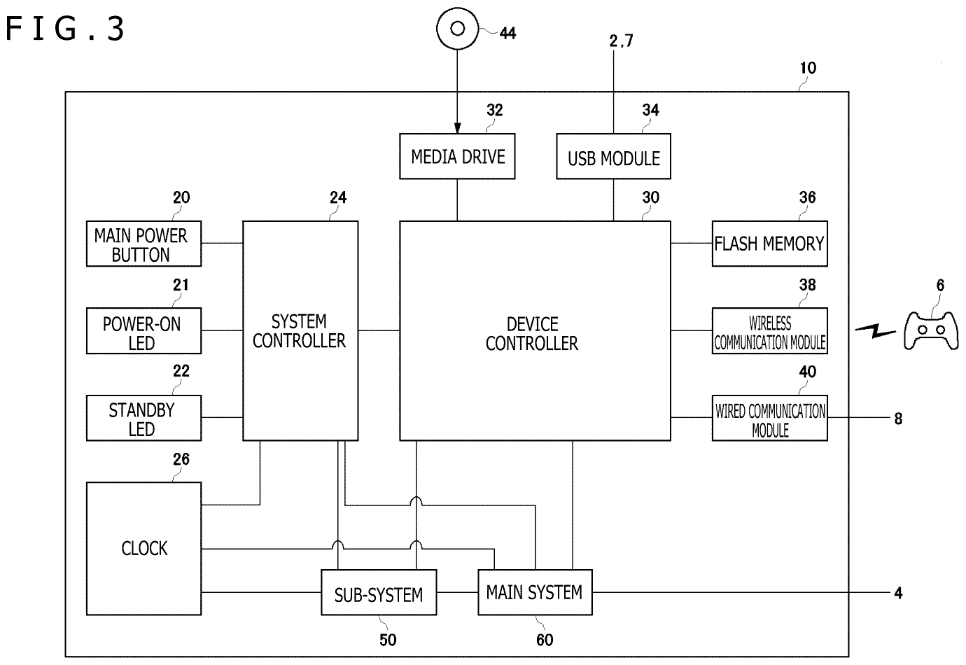

FIG. 3 depicts a hardware configuration of the information processing apparatus 10. The information processing apparatus 10 includes a main power button 20, a power-on LED (Light Emitting Diode) 21, a standby LED 22, a system controller 24, a clock 26, a device controller 30, a media drive 32, a USB module 34, a flash memory 36, a wireless communication module 38, a wired communication module 40, a sub-system 50, and a main system 60.

The main system 60 includes a main CPU (Central Processing Unit), a memory which is a main storage device, a memory controller, and a GPU (Graphics Processing Unit), for example. The GPU is mainly used for computation processing in game software. These functions may be configured into a system-on-a-chip, and formed on a single chip. The main CPU has a function of executing system software recorded in the auxiliary storage apparatus 2, and executing game software recorded in the auxiliary storage apparatus 2 or a ROM (Read Only Memory) medium 44.

The sub-system 50 includes a sub-CPU, a memory which is a main storage device, and a memory controller, for example, but does not include a GPU, and thus, does not have a function of executing game software. The number of circuit gates in the sub-CPU is less than that in the main CPU. Operational power consumption of the sub-CPU is smaller than that of the main CPU. Even when the main CPU is in a standby mode, the sub-CPU is under operation, and the processing function thereof is restricted in order to reduce the power consumption. The sub-system 50 may have a function of automatically downloading a patch file from the patch file providing server 12 during a standby mode.

The main power button 20 is a button on which a user operation input is performed, is disposed on the front surface of a casing of the information processing apparatus 10, and is operated to turn on/off power supply to the main system 60 of the information processing apparatus 10. The power-on LED 21 is lit when the main power button 20 is on. The standby LED 22 is lit during a standby mode when the main power button 20 is off.

The system controller 24 detects that a user depresses the main power button 20. If the main power button 20 is depressed when the main power is off, the system controller 24 obtains the depression operation as a “power-on indication.” Meanwhile, if the main power button 20 is depressed when the main power is on, the system controller 24 obtains the depression operation as a “power-off indication.”

The clock 26 is a real time clock. The clock 26 generates current time-date information, and supplies the current time-date information to the system controller 24, the sub-system 50, and the main system 60.

The device controller 30 is formed as an LSI (Large-Scale Integrated Circuit) that, like a southbridge, exchanges information between the devices. As depicted in the drawing, devices including the system controller 24, the media drive 32, the USB module 34, the flash memory 36, the wireless communication module 38, the wired communication module 40, the sub-system 50, and the main system 60, for example, are connected to the device controller 30. The device controller 30 absorbs differences in electric characteristics and data transfer speeds among the devices, and controls data transfer timings.

The media drive 32 is a drive device that is driven with the ROM medium 44 mounted thereon and reads out a program or data from the ROM medium 44 in which software for a game or the like is recorded. The ROM medium 44 is a read only recording medium such as an optical disk, a magneto-optical disk, or a Blu-ray disc.

The USB module 34 is a module that establishes connection with an external apparatus via a USB cable. The USB module 34 may be connected to the auxiliary storage apparatus 2 and the camera 7 via USB cables. The flash memory 36 is an auxiliary storage device constituting an internal storage. The wireless communication module 38 wirelessly communicates with, for example, the input apparatus 6 in such a communication protocol as the Bluetooth (registered trademark) protocol or the IEEE (Institute of Electrical and Electronics Engineers) 802.11 protocol. It is to be noted that the wireless communication module 38 may be compatible with a digital mobile phone system. The wired communication module 40 performs wired communication with an external apparatus, and establishes connection with the network 3 via the AP 8.

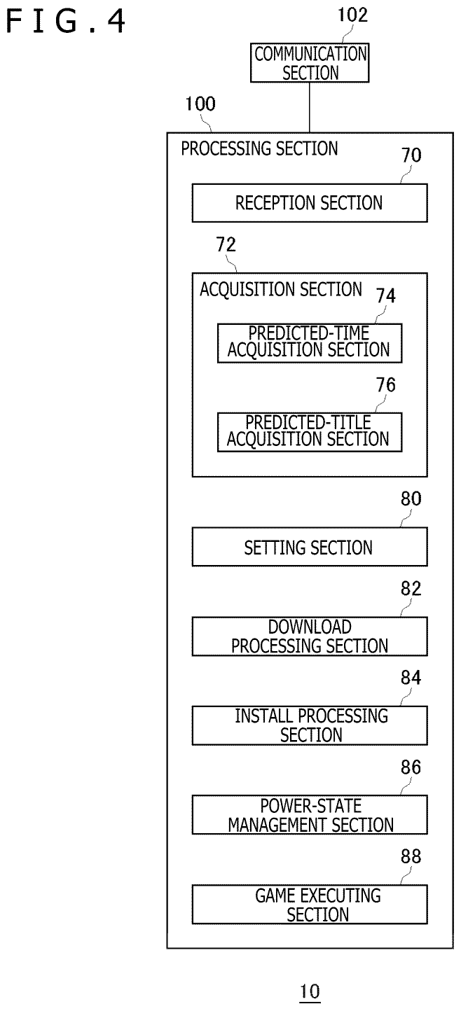

FIG. 4 depicts functional blocks for performing automatic downloading in the information processing apparatus 10. The information processing apparatus 10 includes a processing section 100 and a communication section 102. The processing section 100 includes a reception section 70, an acquisition section 72, a setting section 80, a download processing section 82, an install processing section 84, a power-state management section 86, and a game executing section 88. The acquisition section 72 includes a predicted-time acquisition section 74 and a predicted-title acquisition section 76.

The information processing apparatus 10 includes a computer. The computer executes a program to implement the various functions depicted in FIG. 4. Hardware of the computer includes a memory for loading a program, at least one processor for executing the loaded program, an auxiliary storage device, any other LSI, and the like. The processor includes a plurality of electronic circuits including a semiconductor integrated circuit and LSI. The plurality of electronic circuits may be mounted on one chip, or may be mounted on two or more chips. The functional blocks depicted in FIG. 4 are implemented by cooperation between the hardware and software. Therefore, a person skilled in the art will understand that these functional blocks can be implemented in various ways by hardware only, by software only, or a combination thereof.

The communication section 102 receives operation information regarding a user operation performed on an input part of the input apparatus 6, and provides the operation information to the reception section 70. Further, by communicating with the management server 5 and the patch file providing server 12, the communication section 102 transmits and receives various kinds of information or data. The communication section 102 may have the function of the wireless communication module 38 and the function of the wired communication module 40 depicted in FIG. 3, in combination.

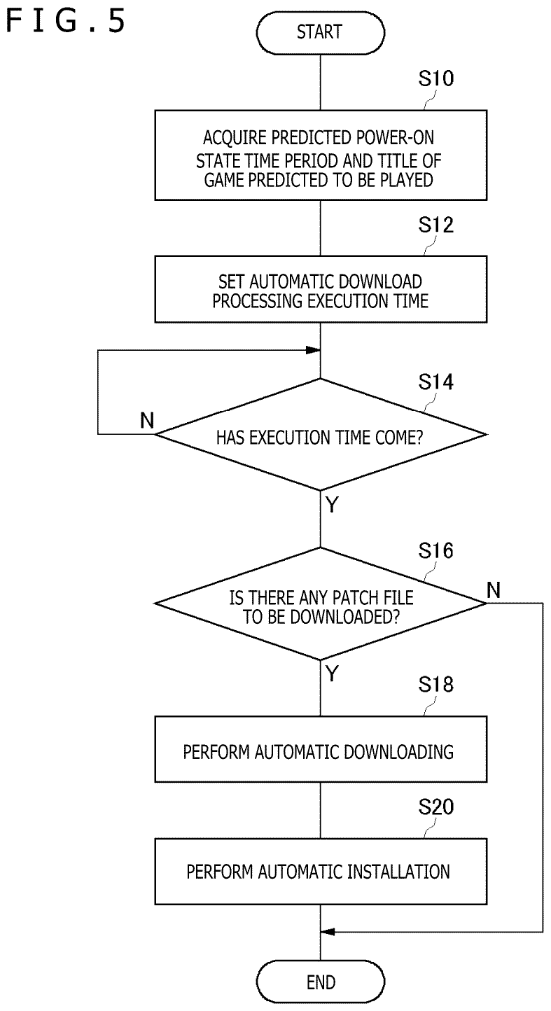

FIG. 5 is a flowchart for automatically downloading a patch file. The acquisition section 72 acquires a behavior of the information processing apparatus 10 predicted by the management server 5 (S10). Specifically, the predicted-time acquisition section 74 acquires a predicted value of a time period during which the information processing apparatus 10 will be on, and the predicted-title acquisition section 76 acquires a title of a game predicted to be executed in the information processing apparatus 10.

In the information processing apparatus 10a of the user A, the predicted-time acquisition section 74 acquires information indicating that a predicted time of startup of the information processing apparatus 10a is 20:00, and a predicted time of transition of the information processing apparatus 10a to a standby mode is 23:00, and the predicted-title acquisition section 76 acquires information indicating that a game of the title A will be executed.

According to the predicted time of startup of the information processing apparatus 10a, the setting section 80 sets an automatic download processing execution time (S12). The setting section 80 may set, as the automatic download processing execution time, a time point that is earlier than the predicted startup time of the information processing apparatus 10a by a predetermined time period. When a maximum processing time period of patch file automatic downloading and automatic installing is Tmax, it is preferable that the setting section 80 set, as the automatic download processing execution time, a time point that is earlier than the predicted time by the maximum processing time period Tmax or longer. For example, the setting section 80 sets, as the automatic download processing execution time, a time point that is earlier than the predicted time by two hours.

The setting section 80 may set the automatic download processing execution time each time the acquisition section 72 acquires a predicted behavior of the information processing apparatus 10 from the management server 5. Thus, in a case where the management server 5 provides a predicted behavior to the information processing apparatus 10a every week, the setting section 80 may set the automatic download processing execution time every week.

In a standby mode, the download processing section 82 waits for arrival of the set execution time (N at S14). When the execution time has come (Y at S14), the download processing section 82 starts automatic download processing. It is to be noted that automatic download processing at the download processing section 82 is not performed during a power-on state but is performed during a standby mode. The power-state management section 86 may prohibit execution of automatic download processing during a power-on state.

The download processing section 82 first inquires of the patch file providing server 12 whether there is any patch file for the game title A to be downloaded (S16). When making the inquiry, the download processing section 82 notifies the patch file providing server 12 of version information regarding a patch file that has already been installed.

After obtaining the inquiry including the version information, the patch file providing server 12 checks whether a patch file newer than the received version is held in the patch file providing server 12. When confirming that the patch file installed in the information processing apparatus 10a is the most up-to-date version, the patch file providing server 12 notifies the information processing apparatus 10a of the fact that there is no patch file to be downloaded (N at S16), and then, the download processing section 82 exits from the automatic download processing. Meanwhile, when confirming that the patch file installed in the information processing apparatus 10a is not the most up-to-date version, the patch file providing server 12 notifies the download processing section 82 of version information regarding a new patch file (Y at S16).

After receiving this notification, the download processing section 82 transmits a download request for the most up-to-date patch file to the patch file providing server 12. The patch file providing server 12 transmits the most up-to-date patch file for the game title A to the information processing apparatus 10a. Accordingly, the download processing section 82 downloads the patch file for the game title A (S18), and the install processing section 84 installs the downloaded most up-to-date patch file onto the auxiliary storage apparatus 2.

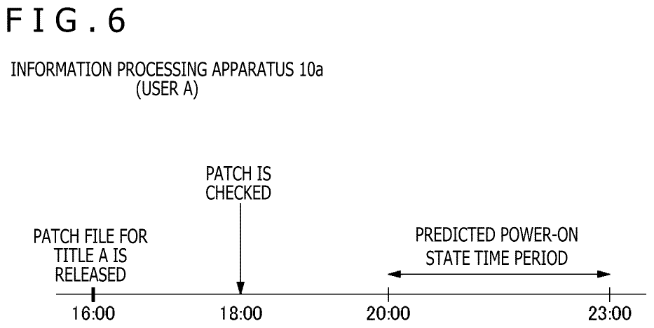

FIG. 6 depicts a time relation between release of a patch and behaviors of the information processing apparatus 10a. The setting section 80 sets an automatic download processing execution time (18:00) that is earlier than a predicted time (20:00) of startup of the information processing apparatus 10a by two hours. In this example, the most up-to-date patch file for the game title A is released at 16:00, and the download processing section 82 executes automatic download processing at 18:00. Therefore, installation of the most up-to-date patch file can be done before the predicted time (20:00) at which the user A will start up the information processing apparatus 10a. As a result, the user A can play the game title A in the most up-to-date state immediately after starting up the information processing apparatus 10a.

As an automatic download processing execution time is set according to a predicted startup time of the information processing apparatus 10a in the above-mentioned manner, a situation in which a most up-to-date patch file has been installed at a time when the information processing apparatus 10a is started up can be created. In addition, targets to be downloaded are limited to predicted titles of games which will be played, whereby a load on the patch file providing server 12 during automatic download processing can be lessened.

It is to be noted that a time period during which access to the patch file providing server 12 concentrates can be predicted because the management server 5 predicts all behaviors of the information processing apparatus 10. Therefore, when notifying each of the information processing apparatuses 10 of a predicted startup time of the information processing apparatus 10, the management server 5 may give an instruction to randomly determine an automatic download processing execution time within a predetermined time width range. In this case, the setting section 80 may set an automatic download processing execution time within a range from a time point that is earlier than the predicted startup time of the information processing apparatus 10 by a first time period to a time point that is earlier than the predicted startup time by a second time period (first time period>second time period). For example, the first time period is “three hours,” and the second time period is “one hour.” The setting section 80 randomly sets the automatic download processing execution time between 17:00 to 19:00 in FIG. 6. For example, in a case where the predicted startup times of many information processing apparatuses 10 are 20:00, the information processing apparatuses 10 randomly set respective automatic download processing execution times within the predetermined time width range. Accordingly, timings at which the respective information processing apparatuses 10 make access to the patch file providing server 12 can be distributed.

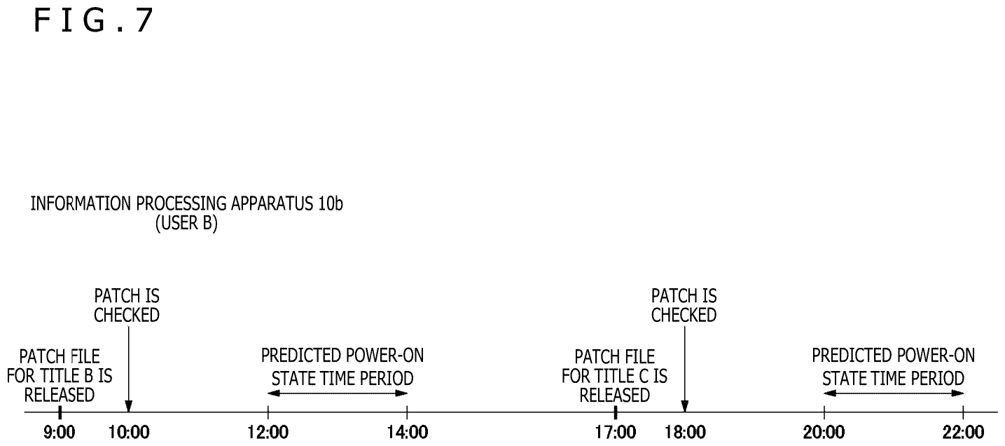

FIG. 7 depicts a time relation between release of a patch and behaviors of the information processing apparatus 10b. With reference to FIG. 2, the predicted-time acquisition section 74 in the information processing apparatus 10b acquires a plurality of predicted times of startup of the information processing apparatus 10b. That is, the predicted-time acquisition section 74 acquires two predicted startup times which are 12:00 and 20:00. In this case, the setting section 80 sets, as automatic download processing execution times, time points that are earlier than the respective predicted startup times by two hours. Therefore, the setting section 80 sets the automatic download processing execution times to be 10:00 and 18:00.

In this example, the most up-to-date patch file for the game title B is released at 9:00, and the download processing section 82 executes automatic download processing at 10:00. Accordingly, installation of the most up-to-date patch file can be done before the predicted time (12:00) at which the user B will start up the information processing apparatus 10b. In addition, the most up-to-date patch file for the game title Cis released at 17:00, and the download processing section 82 executes automatic download processing at 18:00. Accordingly, installation of the most up-to-date patch file can be done before the predicted time (20:00) at which the user B will start up the information processing apparatus 10b. As a result, the user B can play the game of the title B and/or the game of the title C in the most up-to-date state immediately after starting up the information processing apparatus 10b.

The above embodiment exemplifies the present disclosure, and a person skilled in the art will understand that various modifications can be made to a combination of the constituent elements or the process steps and that these modifications are also within the scope of the present disclosure. In the embodiment, the setting section 80 sets an automatic download processing execution time according to a predicted time of startup of the information processing apparatus 10. Alternatively, the management server 5 or the patch file providing server 12 may set an automatic download processing execution time according to a predicted time of startup of the information processing apparatus 10, and then, may notify the information processing apparatus 10 of the automatic download processing execution time.

In the embodiment, when the download processing section 82 executes automatic download processing at the set execution time and is notified by the patch file providing server 12 of the fact that there is no patch file to be downloaded (N at S16), the automatic download processing is exited. In a modification, after being notified of the fact that there is no patch file to be downloaded, the download processing section 82 may execute automatic download processing on a regular basis (for example, every 30 minutes) until the predicted startup time.

In the embodiment, the setting section 80 sets, as an automatic download processing execution time, a time point that is earlier than a predicted startup time by two hours. Alternatively, an automatic download processing execution time may be set according to a network environment of the current day, for example.

In a case where the information processing apparatus 10 is started up when automatic downloading of a patch file is under execution, the download processing section 82 may continue the automatic download processing. It is to be noted that, in a case where a patch file being automatically downloaded is for a game which is playable even if the patch file is not the most up-to-date, when the information processing apparatus 10 is started up during automatic downloading, the download processing section 82 may immediately suspend the automatic download processing.

### INDUSTRIAL APPLICABILITY

The present disclosure is applicable to the technical field of updates of game software functions.

### REFERENCE SIGNS LIST

1: Information processing system
5: Management server
10, 10a, 10b: Information processing apparatus
12: Patch file providing server
70: Reception section
72: Acquisition section
74: Predicted-time acquisition section
76: Predicted-title acquisition section
80: Setting section
82: Download processing section
84: Install processing section
86: Power-state management section
88: Game executing section
100: Processing section
102: Communication section

1. An information processing apparatus that executes game software, the information processing apparatus comprising:
a setting section that sets an automatic download processing execution time which is set according to a predicted time of startup of the information processing apparatus, the predicted time being obtained by prediction based on past history information regarding the information processing apparatus; and
a download processing section that executes automatic download processing of a patch file at the set execution time.

2. The information processing apparatus according to claim 1, further comprising:
an acquisition section that acquires a predicted time of startup of the information processing apparatus, wherein the setting section sets the automatic download processing execution time on a basis of the predicted time.

3. The information processing apparatus according to claim 2, wherein
the setting section sets, as the automatic download processing execution time, a time point that is earlier than the predicted time by a predetermined time period.

4. The information processing apparatus according to claim 2, wherein
the setting section sets the automatic download processing execution time between a time point that is earlier than the predicted time by a first time period and a time point that is earlier than the predicted time by a second time period (first time period>second time period).

5. The information processing apparatus according to claim 2, wherein
the acquisition section acquires a plurality of the predicted times, and
the setting section sets a plurality of the execution times.

6. The information processing apparatus according to claim 2, wherein
the acquisition section acquires a title of a game predicted to be executed by the information processing apparatus according to the past history information regarding the information processing apparatus, and the download processing section executes automatic download processing of a patch file for the predicted game title.

7. A method for downloading a patch file for game software onto an information processing apparatus, the method comprising:
a step of setting an automatic download processing execution time which is set according to a predicted time of startup of the information processing apparatus, the predicted time being obtained by prediction based on past history information regarding the information processing apparatus; and
a step of executing automatic download processing of the patch file at the set execution time.

8. A program for causing a computer to implement:
a function of setting an automatic download processing execution time which is set according to a predicted time of startup of the computer, the predicted time being obtained by prediction based on past history information regarding the computer; and
a function of executing automatic download processing of a patch file at the set execution time.
